(19) United States
(12) Patent Application Publication
(10) Pub. No.: US 2025/0339952 A1
(43) Pub. Date: Nov. 6, 2025

(54) LIGHTWEIGHT POWERED ELBOW EXOSKELETON FOR MANUAL HANDLING TASKS

(71) Applicant: Arizona Board of Regents on Behalf of Northern Arizona University, Flagstaff, AZ (US)

(72) Inventors: Zachary F. LERNER, Flagstaff, AZ (US); Daniel COLLEY, Flagstaff, AZ (US)

(73) Assignee: Arizona Board of Regents on Behalf of Northern Arizona University, Flagstaff, AZ (US)

(21) Appl. No.: 19/196,598

(22) Filed: May 1, 2025

Related U.S. Application Data
(60) Provisional application No. 63/641,360, filed on May 1, 2024.

(51) Int. Cl. B25J 9/00

(52) U.S. Cl. CPC B25J 9/0006

(57) ABSTRACT

A powered elbow exoskeleton for assistance in the lifting and movement of objects is disclosed. The device has control and motor components arranged on a hip belt, and force is transmitted from motors to pullies arranged laterally to a user's elbow by cables. A controller actuates the pullies to provide extension and flexion torque to a hinged assembly having an upper arm portion and a forearm portion. The device includes pressure sensors in an instrumented glove to measure pressure being exerted by the user's finger(s) and palm(s). The sign of the difference between finger pressure and palm pressure is determined and used to determine the direction of assistive torque provided by the device.

### CROSS-REFERENCE TO RELATED APPLICATIONS

The present application claims priority to U.S. Provisional Application 63/641,360 entitled “LIGHTWEIGHT POWERED ELBOW EXOSKELETON FOR MANUAL HANDLING TASKS”, filed on May 1, 2024, the entirety of which is incorporated herein by reference.

### STATEMENT REGARDING FEDERALLY SPONSORED RESEARCH

N/A

### BACKGROUND

Manual handling tasks within industrial environments often entail repetitive and demanding arm movements which can lead to musculoskeletal injuries, mainly affecting the elbow and shoulder, resulting in a significant burden on worker health and productivity. In response, wearable exoskeletons have emerged as a promising solution to reduce the risk of injury by providing external support and aid to the musculoskeletal system, consequently alleviating the physical strain on workers while amplifying their performance.

Over the past few decades, academic and commercial entities have engaged in the pursuit of developing upper extremity exoskeletons using both passive and active designs. Passive exoskeletons have demonstrated utility in tasks like maintaining tools overhead for prolonged durations or executing repetitive movements. These passive exoskeletons assist the user's shoulders during overhead tasks through spring mechanisms. However, relying on passive mechanisms that can only provide support in a single direction through a limited range of motion limits the functionality of these devices. Hence, there may be a need for more adaptable devices that can provide bi-directional assistance through an unrestricted range of motion.

Prior work on upper-limb exoskeletons have predominantly centered on exploring the advantages of providing unidirectional support to the shoulder, while elbow joint assistance has not been well documented, particularly for dynamic lifting tasks. Few studies have investigated their use for dynamic tasks spanning above and below the shoulder. Exoskeletons aimed at reducing muscle strain for tasks below shoulder height have primarily considered slow and isometric tasks such as static load carries and holds. Moreover, active systems are often tested in a lab setting in which the actuation control of the device is managed by a secondary operator, outside of the human-robot construct. Consequently, there remain gaps in the literature on investigating the effects of assisting dynamic load bearing movements and the challenges associated with realistic controls in a real or simulated working environment.

### BRIEF SUMMARY

Embodiments of the invention are directed to a powered exoskeleton for applying force, in both flexion and contraction, to an elbow joint. In an embodiment, a powered exoskeleton for the user's arms is described. The device includes a battery pack and controller housing, which may be attached to the user with a hip belt and stabilizing straps. The battery pack and controller housing includes a control board, which may be a printed circuit board including a programmable controller, transitory and non-volatile memory or data storage (e.g., RAM and non-volatile storage such as an SSD or SD card), data input/output interfaces and other hardware typical of a computing device. The control board supplies power and motor control signals to one or more (and preferably a pair) of motor housings, which include bi-directional, electronic, rotary motors. For each motor, the motor's output shaft is coupled to a drive sprocket which may include teeth that interface with a chain. The chain may be coupled, on each of its ends, to a transmission line, which may be a chain or cable, such that rotation of the motor in a first direction pulls on one transmission and rotation of the motor in the second, opposite direction pulls on the other transmission line. In preferred embodiments, the transmission lines are Bowden cables, which have an inner cable surrounded by a cable sheath, where the cable sheaths are anchored on a first end, proximate to the motor. The cable sheath may have a tensioning apparatus (e.g., a barrel screw), that tensions the sheath relative to the inner cable.

In a preferred embodiment, the device includes an upper arm portion and a lower arm portion. Each portion includes a linear, structural member arranged laterally to and in parallel with long axes of a wearer's upper and lower arms, respectively. Each portion may be coupled to the wearer's upper and lower arm, respectively, with cuffs (i.e., a bicep cuff and a forearm cuff for each of the upper and lower arm portion). The linear, structural members of the upper and lower portions are coupled together at their ends by rotational bearing, which is arranged lateral to an elbow joint of the wearer. The rotational bearing is coupled to a pulley sheave, which is coupled to each of the transmission lines (e.g., the Bowden cables) such that rotation of the motor in first direction tends to rotate the lower arm portion toward the upper arm portion (i.e., provide flexion assistance to the elbow joint), and rotation of the motor in a second direction tends to rotate the lower arm portion away from the upper arm portion (i.e., provide extension assistance to the elbow joint).

In preferred embodiments, a torque sensor is provided between the upper arm portion's linear, structural member and the lower arm portion's liner structural member to measure torque being applied between the upper and lower arm portions by the combination of the motor-driven assistance and the user's own applied force, or alternatively, just the user-supplied torque.

In preferred embodiments, the device includes a wearable glove as a separate component. The wearable glove includes one or more pressure sensors which may be force sensing resistors (FSRs). FSRs are electrically coupled through electrical connections (i.e., pairs of cables) or a sensor port, which may be arranged on the glove. The cable port electrically connects the FSR connections through a cable to the control board, such that the programmable controller receives data regarding the resistance state of each FSR. In an embodiment, one or more FSRs are positioned on the fingers (digits) of the wearer of the device, to detect pressure between the user's digits and some external surface. In a preferred embodiment, FSRs are provided on a plurality of digits (e.g., the second, third and fourth digits). One or more pressure sensors are also provided on the glove over the wearer's palm, to measure pressure between the user's palm and some external surface.

Certain embodiments are directed to a method of controlling and using the elbow exoskeleton just described. In certain embodiments, the control board receives sensor input from the pressure sensors located at a wearable glove. Under certain conditions, the ratio of a measurement of pressure measured by one or more digit pressure sensors to a measurement of pressure measured by one or more palm pressure sensors determines whether the controller/processor directs the exoskeleton to provide flexion versus extension assistance. In particular, if a measure of pressure measured by the one or more digit pressure sensors exceed a measure of pressure measured by the one or more palm pressure sensors, the processor determines that flexion assistance is required and controls the exoskeleton to provide flexion assistance. If a measure of pressure measured by the one or more palm pressure sensors exceeds a measure of pressure measured by the one or more digit pressure sensors, the processor determines that extension assistance is required and controls the exoskeleton to provide extension assistance. In effect, the ratio of a pressure measurement at the fingers to a pressure measurement at the palm determines whether the user is engaged in pulling an object or pushing an object, and the exoskeleton is controlled to provide assistive elbow force in the appropriate direction. The magnitude of force provided may be a predetermined, fixed quantity. Alternatively the amount of torque may be determined by measuring torque being provided by the user (with the torque sensor), applying a scale factor to the user-provided torque, and then providing assistance in proportion to the scaled user-provided torque. In certain cases, the device has a zero torque mode where finger and or palm pressure, if measured to be below a predetermined threshold, causes the controller to supply just enough torque (either in flexion or extension) to counteract the inertia of the device, that is, to make the device transparent to the wearer.

While the control scheme has been described in connection with one arm of the device, it is to be understood that assistive force is provided to both arms independently, and that both arms are independently controlled according to the methods set forth above.

Embodiments of the invention have certain advantages, in particular, they provide effective assistance in a variety of dynamic moving and living tasks typical of an actual work environment. The embodiments described herein: (1) minimize mass placed distally on the arms to reduce the burden while wearing the device; (2) provide bidirectional actuation for both elbow flexion and extension; (3) deliver a relevant amount of peak torque (e.g., 10-15 Nm per arm) to effectively assist the execution of dynamic lifting tasks; (4) provide for minimal protrusion from each arm to optimize the range of motion and overall comfort for the user during regular activities; and (5) provide seamless control enabling assistance across a variety of lifting tasks. Additional advantages will become evident upon consideration of the following Detailed Description.

### BRIEF DESCRIPTION OF THE DRAWINGS

The drawings described herein constitute part of this specification and includes exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts renderings of the exoskeleton design including the instrumented glove, and exploded views of the waistbelt, motor cartridge, and arm subassemblies according to one embodiment.

FIG. 2 illustrates a waistbelt including a battery and control box and a motor cartridge in additional detail.

FIG. 3 illustrates the components of an upper and lower arm portion of an elbow exoskeleton in additional detail.

FIG. 4 illustrates components of a wearable, instrumented glove according to an embodiment in additional detail.

FIG. 5 depicts a custom PCB layout for a controller board including a programmable processor according to one embodiment.

FIG. 6 depicts an exoskeleton control diagram with the setup sequence and the main logic loop.

FIG. 7 depicts (A) the measured and desired torque and rise time and overshoot for a 10 Nm torque setpoint change during a benchtop step response test, and (B) the prescribed and measured torque during a representative lifting task, with root mean square error (RMSE) reported.

FIG. 8 depicts (A) the relative reduction in the mean and peak bicep sEMG for completing different box lift magnitudes with vs without the exoskeleton assistance, and (B) average bicep sEMG waveforms for each lift magnitude for the with vs without exoskeleton conditions. Note that the percentages in (B) represent the portion of the load alleviated by exoskeleton assistance.

FIG. 9 depicts (A) depictions of the box lift and box loading tasks and (B) relative changes in mean sEMG with versus without the exoskeleton for box lift 10 and 20 kg, and box loading 10 kg tasks averaged across the full cohort, n=9. * denotes a statistically significant difference. Error bars denote standard deviation.

FIG. 10 depicts (A) depictions of the box press and compound lift tasks and (B) relative changes in mean sEMG with vs without the exoskeleton for the 10 kg box press and compound lift tasks for the single subject experiment. * denotes a statistically significant difference. Error bars denote standard deviation.

FIG. 11 depicts plots of the mean applied torque for each task from participant P5 measured from the onboard torque sensor. Note the level of assistance for each task aimed to deliver 12 Nm of torque for the majority of the lift cycle.

FIG. 12 depicts a bar chart displaying the number of box-lifts each participant completed before fatigue (20 kg box) with and without the exoskeleton. Note that all participants were able to complete more lifts with the exoskeleton than without.

FIG. 13 depicts perceived exertion ratings from each task with and without the exoskeleton. * denotes a statistically significant difference. Error bars denote standard deviation.

FIG. 14 depicts perceived discomfort ratings from each task while wearing the exoskeleton. Error bars denote standard deviation.

FIG. 15 is a data table showing information on participants in a validation test.

FIG. 16 is a data table summarizing previous studies on untethered elbow-joint exoskeletons evaluated for lifting tasks.

### DETAILED DESCRIPTION

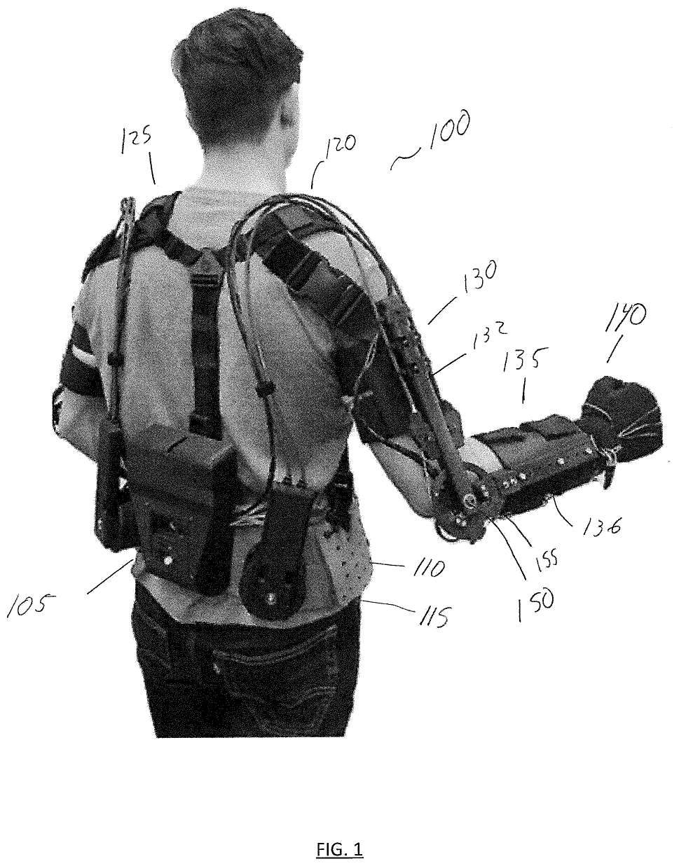

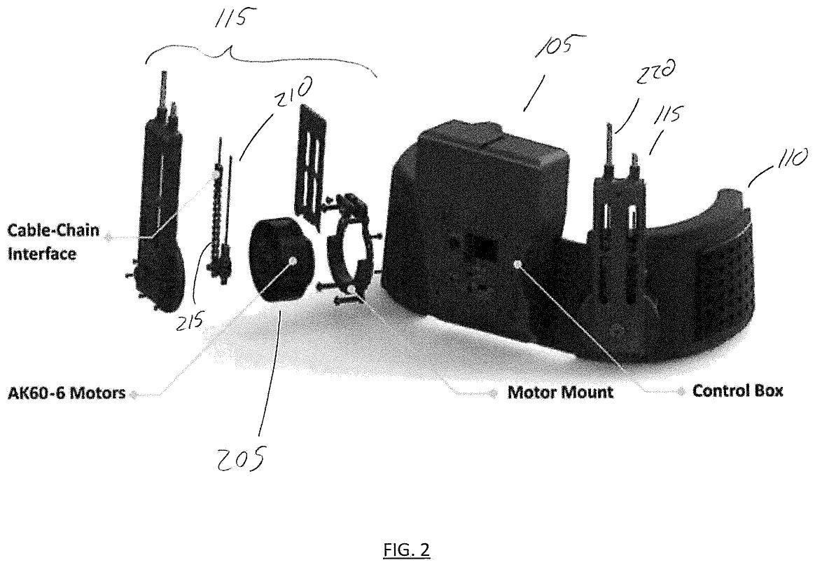

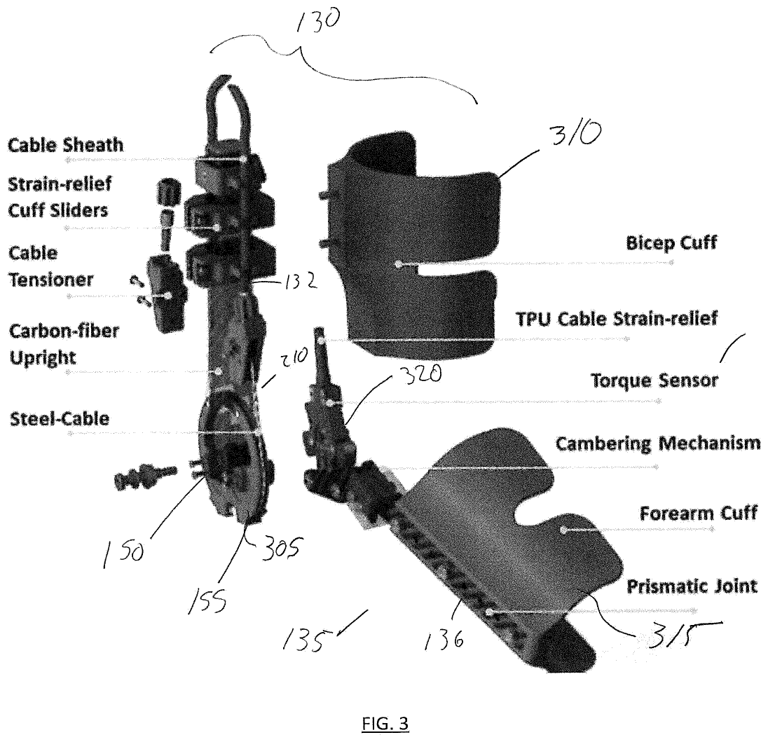

Referring now to FIGS. 1-4, there is shown an active bi-directional elbow exoskeleton including a set of force mapping gloves 100. The exoskeleton design includes a waist belt assembly 115, to which is attached a battery and control box 105 including the system's electronic components and a pair of motor housings 115. The actuation and electronical components of the system are deliberately positioned on the hips to effectively mitigate distal inertial repercussions, that is to say. This arrangement also advantageously removes weight from the arms and places it more comfortably on the wearer's center of mass. The device 100's motor housings 115 include a pair of rotary electric motors 205 that provide be-directional actuation, independently, to each of the exoskeleton's two elbow joints. While rotary motors are shown in FIGS. 1-4, other sorts of actuators are usable, particularly in connection with the control schemes described below, such as linear electric motors, hydraulic pistons, pneumatic pistons, pneumatic bladders, combinations thereof, and/or any other device capable of generating a force. In a preferred embodiment, shown in the figures, motors 205 are brushless DC motors (AK60-6 V1.1, CubeMars) with integrated controllers and a 6:1 gearbox, achieving a continuous torque of 3 Nm at 233 rpm and a peak torque of 9 Nm. The output shaft of the motor is coupled to a toothed motor sprocket, which engages with a pair of cables (or preferably, a single cable 210 that loops around the motor sprocket). The cable 210 may include a chain section or cable-chain interface 215 that interfaces directly with the teeth in the sprocket. Through the cable-chain transmission mechanism 210, the motor sprocket interfaces with a steel cable housed in Bowden tubes 220 to transmit torque to a pulley 155, described below and in reference to FIGS. 1-3.

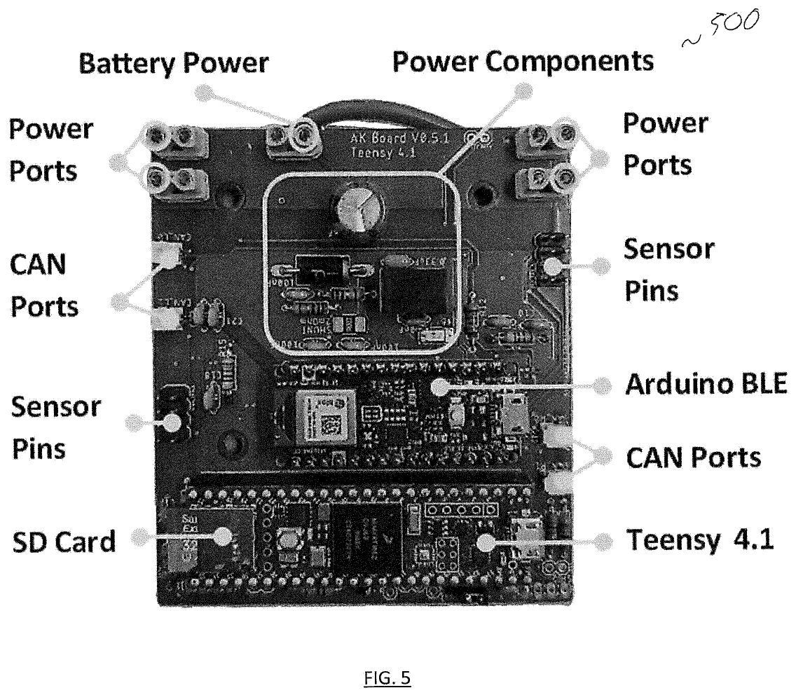

Referring now to FIGS. 1 and 5, the waist assembly 115 also includes a control box 105, which houses one or more batteries (e.g., a DC battery) and a control unit which may include one or more electronic control boards such as board 500 of FIG. 5. The one or more control boards include essential electronic power, communication, and control components on a printed circuit board. The control board may include memory (both volatile and non-volatile), one or more programmable processors, power conditioning components (e.g., DC/DC converters), controllers, data I/O transceivers, data input and output devices (e.g., buttons, speakers, LED display lights etc.). The one or more batteries housed in the control box 105 may be any device capable of storing and delivering electrical power, with examples including nickel cadmium, nickel metal hydride, lithium ion, lead acid, alkaline, lithium batteries, and so on. The one or more batteries may be rechargeable or single use. The control unit may further include circuitry and components for connecting and rectifying external electrical power received from external sources (e.g., AC power) to recharge the one or more batteries, in some embodiments.

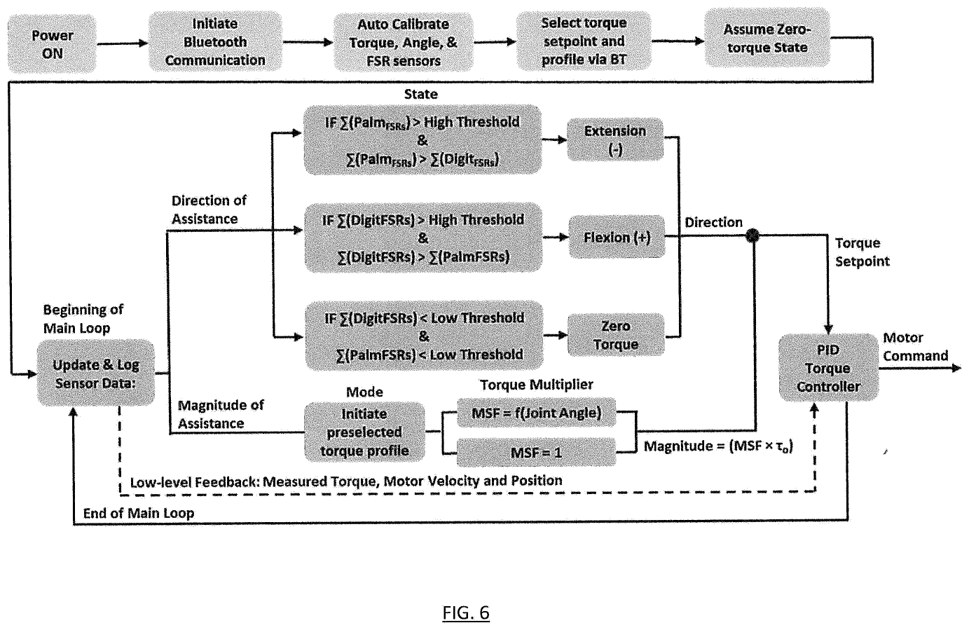

Referring to the specific embodiment shown in FIG. 5, a control board is provided that includes a programmable processor (Arbuino BLE), a dedicated microcontroller (Teensy 4.1). The control board may also include one or more power ports, which may supply power to the board from a non-illustrated external power supply that receives power from the one or more batteries, and through which power may be supplied to the motors described above. The board may also include a variety of data I/O interfaces (e.g., Bluetooth transceivers, CAN Ports, Sensor signal inputs, etc.). The board may include volatile and non-volatile memory or storage (e.g., and SD card) in electronic communication with the processor and controller. The processor and controller are configured to execute computer executable instructions stored in non-volatile memory to cause the processor and controller to, together or separately, implement control method steps that are described elsewhere in this disclosure, e.g., below in connection with FIG. 6.

In a specific example of the exoskeleton of FIGS. 1-4, control box 105 includes a 22.2 V 1800 Mah LiPo battery, and two embedded microcontroller development boards: the Teensy 4.1 development board that handled the data acquisition, control, and actuator communication, and the Arduino Nano 33 BLE development board that received and communicated state information to a custom smartphone GUI via Bluetooth Low Energy.

Referring now to FIGS. 1-3, an elbow exoskeleton includes an upper arm portion 130 and a lower arm portion 135. Each of the upper and lower arm portions include a linear structural member (132, 136). In one example, these members are tubular carbon fiber members with closed circumferential cross sections over most of their length, but other shapes and materials are possible such as fiberglass, steel, aluminum, etc. Various combinations and shapes of structural members usable in exoskeletons of the type described in this application are disclosed in U.S. Patent Publication No. US20210378904A1 (U.S. patent application Ser. No. 17/343,628, published on Dec. 9, 2021), entitled “Cable-actuated, kinetically-balanced, parallel torque transfer exoskeleton joint actuator with or without strain sensing”, which is incorporated herein by reference for all purposes. Generally, that application describes systems and methods for arranging exoskeleton components such as motors, Bowden cables, chain interfaces, rotational bearings, pullies, and linear components which are usable with the embodiments described herein.

The upper and lower arm portions of the instant exoskeleton together form a hinged assembly, and the two linear members are hingedly coupled together though a rotational bearing 150. The rotational bearing 150 is coupled to a pulley 155. Pulley 155 is coupled to the ends of cables 210, enabling bi-directional rotational actuation of pulley 155 through bi-directional rotation of the output shaft of motor 205. Specifically, by rotation of the output shaft of motor 205, a motor sprocket at the motor rotates. The motor sprocket is engaged with chain 215 though teeth in the sprocket such that rotation of the motor output shaft causes the chain to be pulled in a first or a second opposite direction. The chain 215 is coupled to cable 210, the free ends of which are routed through Bowden cable sheaths 120 to pulley 155, which is then rotated by cable tension in a first or second rotational direction. This causes linear member 136 of lower arm portion 135 to be pulled toward upper portion 130, or alternatively, for linear member 136 to be rotated away from upper portion 130. Thus, this arrangement enables the motors in the motor housings 115 to drive the elbow exoskeleton in flexion or extension independently. The diameter of pulley 155 is chosen for reasons of mechanical advantage, and in one embodiment, the pulley is configured to facilitate an additional 4.5:1 reduction over that provided by the motors.

The upper and lower armed portions are positioned on the arm of a user such that the axis of rotation of the rotational bearing 150 is aligned with the elbow joint (i.e., the angle of rotation of the user's elbow joint). The device is mounted to the user's arm, and force is transmitted to the user's arm though a bicep cuff 310 and a forearm cuff 315. Bicep cuff 310 is detachably mounted to linear member 132, and forearm cuff 315 is detachable mounted to linear member 136. In certain embodiments the cuffs 310 and 315 may be integral to their respective linear members. In an optional embodiment, cambering mechanisms may be provided to adjust the angles between the cuffs and the plane in which the linear members rotate, which may be useful for comfort and fit. In addition to the cuffs, the device's alignment to the user is maintained through a custom lightweight harness 125, which couples hinged assembly (130 and 135) to the user through adjustable straps. Harness 125 also helps to bear the wight of the control box 105 and motor housings 115. Together, the harness 125 and arm cuffs establish seven points of contact at the forearms, biceps, hip, and shoulders of the user.

The hinged assembly may also include a torque sensor 320, which may be coupled between linear members 132 and 136 to measure user applied torque between the upper and lower portion of the device (i.e., the amount of torque being exerted by the user through the user's own elbow joint). In the example of the figures, torque sensor 320 is a custom strain-based torque transducer placed at the elbow joint between the pulley 155 and the forearm 135. Torque sensor 320 provides torque measurement data used by controller 500 for low-level closed-loop torque control. Additionally, certain embodiments may include a joint angle sensor located at the rotational bearing, which can measure the joint angle made between the upper and lower arm portions (e.g., between the linear members of the two parts). The joint angle sensor may also measure the speed with which the angle between the two portions is changing.

Barrel adjusters were mounted to the carbon fiber upright (2040N11, McMaster-Carr) to quickly fine-tune cable tension. Cuff sliders made of a 3D printed nylon (Onyx, MarkForged) with carbon fiber reinforcement were designed to manage cable housing reaction forces, provide strain relief to signal lines, structurally support and transmit torque reaction forces to the bicep cuffs, and allow for quick adjustments to the cuffs vertical positioning to suit varying arm lengths. The load transfer interfaces were constructed using custom-fit bicep and forearm cuffs fabricated from a 3D printed nylon-carbon composite with isotropic carbon fiber inlay (Carbon Fibers, Markforged), offering a blend of flexible rigidity, comfort, and lightweight properties to ensure efficient load transfer. Four sizes (S, M, L, XL) were built and layered with high density neoprene foam to accommodate a range of arm diameters while addressing varying arm lengths through extendable prismatic joints.

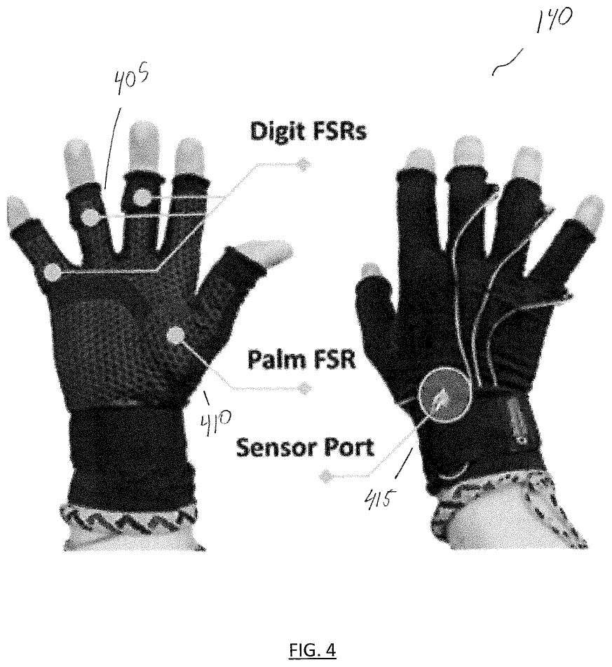

Referring now to FIGS. 1 and 4, an elbow exoskeleton also includes a pair of instrumented gloves 140. Gloves 140 each include pressure sensors 405, 410, and specifically, one or more pressure sensors located on the palm-side (i.e., ventral side) of the user's fingers (digits), and one or more sensors 410 located on the palm-side (i.e., ventral side) of the user's palms. In one embodiment, each glove includes three-digit pressure sensors on the palm side of the user's digits at various points along their length, and one palm pressure sensor on the thenar eminence. Other combinations of the number of sensors and their positions on the hand are possible, however, the preferred arrangement is to separately measure force being applied by the user through the fingers and force being applied by the user through the palm. Any combination of the number and placement of sensors to accomplish this is acceptable. In the example of the figures, the pressure sensors are force sensitive resistors (FSRs), but this is not a requirement. Piezoresistors, piezoelectrics, capacitive pressure sensors, optical pressure sensors, resonant pressure sensors, or other means of sensing pressure or force are usable. The conductors associated with the sensors may be routed to a sensor port, which may be connected through cabling 120 to the control board 500 (i.e., to “sensor pins”).

### Sensing and Control Strategy

The device described above in reference to FIGS. 1-5 may be used in conjunction with a variety of sensing and control strategies, however, a preferred sensing and control strategy will now be described. It will be appreciated that the sensing and control strategy to be described is not limited to the device described above but may be used with any powered elbow exoskeleton device that includes the capability to measure finger and palm force. Additionally, the control methodology to be described includes both a method and arrangement for determining the direction of assistive force supplied by an elbow exoskeleton, but also the magnitude of the force. While both these methodologies are preferably combined in the preferred embodiments, this is not required or limiting. Each of these two methodologies may be combined or used separately. Additionally, while the control methods to be described are useful for assistive exoskeletons to be used in the workplace, they are equally applicable to devices that provide assistance to persons who are disabled. They may also be used with powered protheses rather than exoskeletons. They may also be applicable to robots, where there is no human user. They may also be usable for other sorts of powered joint devices, such as leg exoskeletons, where control is determined by measurements of force applied through toes versus the sole or balls of the feet. Additionally, in the discussion of control methodologies that follows, the control (sensing and driving) methods are applied to each arm of the exoskeleton device individually.

The lack of a cyclic nature and pattern-based events for manual upper-limb handling presents a major design challenge for the control of an exoskeleton capable of assisting during a variety of lifting tasks. The design of a flexible bi-directional control strategy suited for a range of tasks within the working environment should be able to infer (1) which movements require assistance and (2) the direction of assistance needed, both with minimal intervention. The approach described herein meets those requirements and is centered on the simplified principle that elbow flexion (closing of the angle between the forearm and the upper arm) is desired when the user is pulling on an object, then conversely elbow extension (opening of the angle between the forearm and the upper arm) is desired when the user pushes away with their hand. Detecting these states are then based on the concept that pulling motions often produce more pressure on the digits than palms, and vice versa when it comes to pushing. It follows that the direction of assistance for the elbow joint can be determined based on the force distribution across the hand while the necessity of that assistance can be determined based on the magnitude of the difference (i.e., when forces are equally distributed, no desired assistance is assumed).

To infer task directionality, the elbow joint is classified into three distinct states: (1) zero-torque state, wherein the user requires no assistance; this enables the exoskeleton to trail movements while alleviating transmission resistances at the elbow joint; (2) flexion state, indicating the need for positive torque assistance from the system; and (3) the extension state, signifying the requirement for negative torque assistance to facilitate extension. Utilizing the principles mentioned above, the exoskeleton ascertains the desired state through a live assessment of the two FSR input signals in the main control loop, as shown in FIG. 6. The sensor signals are sampled at 500 Hz and are smoothed using an exponential moving average filter then normalized using static force calibration parameters. The palm and digit signals are summed by group and the sign of the difference is utilized to determine the direction of assistance. The magnitude of the difference is compared to a predetermined threshold value which it must exceed to trigger assistance. In one example, this is accomplished by passing the difference signal through a Smitt trigger where it must surpass a high threshold to initiate the given state, maintaining that state until the signal goes beneath the low threshold. When the magnitude of the difference between normalized FSR signals is beneath the high threshold and has previously descended past the low threshold (Smitt Trigger Principal) the zero-torque state is presumed. This accommodation facilitates uninhibited motion between activities when external support is not essential (e.g., holding a cup, using a tablet, writing a note).

As is set forth above, and shown in FIG. 6, the controller (e.g., the controller or processor of FIG. 5) may determine that the device is in one of three states based on absolute and relative measurements between finger and palm pressure sensors. A first state, a zero-torque state, is determined when a pressure measurement derived from the finger pressure sensors fails to exceed a first predetermined finger pressure threshold and a pressure measurement derived from the palm pressure sensor(s) fails to exceed a first predetermined palm pressure threshold. These are the “low thresholds” shown in FIG. 6. The measurements of finger and palm pressure may be compared to the thresholds after some processing, i.e., summing individual finger and palm sensors, averaging, moving averaging, normalization, etc. The thresholds may be determined experimentally. They may also vary with time. They may be determined on the basis of time series measurements of pressures measured by the glove sensors during known periods of low-intensity activity. For example, if the user is engaged in a long period of activity for which no assistance is desired or required, the peak pressures measured during that period can be selected as the low thresholds. The goal is for the device to be in the first state when the user is doing nothing, or low intensity tasks that do not require assistance. When the device has determined that is in its zero-torque state, the motor may be controlled to do nothing. In this case, the device will tend to interfere with the user's natural movements (that is, the user must exert some arm force to move the device as the user goes through normal movements). Thus, the preferrable action for the zero-torque state is for the device to trail the user's movements by supplying just enough torque that the device is transparent to the user. This may be accomplished by determining the direction of the user's angle movements from a joint angle sensor, and then supplying just enough torque in the direction of joint movement to minimize the torque being measured by the torque sensor (i.e., just enough torque to prevent the user from having to push or pull against the inertia of the device).

The other two states indicate the provision of a high level of extension or flexion torque. The device may enter the extension state when a measurement of palm pressure exceeds a second palm pressure threshold (the “high threshold” of FIG. 6), and when the measure of palm pressure exceeds a measure of digit pressure. In this state, the device provides flexion assistive torque to the joint. The device may enter the flexion state when a measure of digit pressure exceeds a second digit pressure threshold and the measure of digit pressure exceeds a measure of palm pressure. The second thresholds may be determined experimentally. They may also vary with time. For example, the second thresholds may be determined in terms of a percent departure from the low thresholds described above (e.g., 200% of the low threshold is the high threshold). The high thresholds may also be determined by observations regarding pressures actually measured during various pulling, pushing, or lifting tasks.

The magnitude of the applied torque may be determined in a number of ways. The magnitude may be a predetermined and fixed amount of assistive torque, e.g., 12 Nm as in the validation experiments discussed below. Alternatively, the torque sensor may be used to measure an amount of user-supplied torque when the user is attempting to lift or push some object, and assistive torque can be supplied that proportionate to the user supplied torque (e.g., the assistive torque is the user applied torque value times some scale factor like 2, 3, 3.5, etc.). Additionally, the amount of assistive torque can be user selectable on the basis of the anticipated weight of the object to be moved. Assistive torque may be applied at a constant level throughout the movement between the upper and lower arm portions, or it may vary according to a torque profile, as a function of the measured angle between the upper and lower portions measured by the angle sensor. For example, less torque may be provided at the start of the movement; it may then ramp up in the beginning of the movement to a predetermined peak. In some cases, it may be desirable to ramp down the applied torque as the movement nears its end. Torque may also be applied on the basis of timing of the movement. For example, torque may gradually ramp up toward a predetermined peak setpoint starting with detection of the desired movement (i.e., according to the application of the criteria of FIG. 6 determining that the device has entered a flexion or extension state). This approach was used in the validation experiments set forth above, and a ramp-up of torque has the advantage of avoiding shocks to the user that would be caused by a sudden application. The ramp up curve may be linear, or it may some other function such as a parabolic or exponential curve.

Other strategies for setting the magnitude of the applied torque are possible. For example, a torque profile may be generated and stored in the control unit's memory. The torque profile may include a maximum torque setpoint, and optionally, a waveform specifying how torque is to be ramped up or down when the device detects a lift or a push. Different torque profiles can be retrieved and applied depending on real-time sensed events such as a pull or a push. Additionally, a user may have the ability to manually adjust the magnitude of the applied torque with a data input device in communication with the controller/processor (e.g, a physical knob or switch, a software GUI, or some other interface).

In certain embodiments, torque is provided proportional to magnitude of the glove sensor reading (i.e., as a function of the scaled distribution from the pressure sensors embedded within the gloves; when the force distribution is higher on the fingers it elicits an elbow flexion torque proportional to the distribution magnitude, while a force distribution higher on the palms elicits an elbow extension torque proportional to the distribution magnitude). The effect here will be that heavier objects will elicit higher torques.

In certain embodiments, torque is provided proportional to the estimated load moment (a function of force magnitude/pressure distribution multiplied by the moment arm of the load based on the elbow angle measurement and upper arm length and orientation).

A prototype powered elbow exoskeleton was constructed in accordance with this disclosure and was characterized and validated. A discussion of that work follows.

### Closed-Loop Torque Tracking Validation

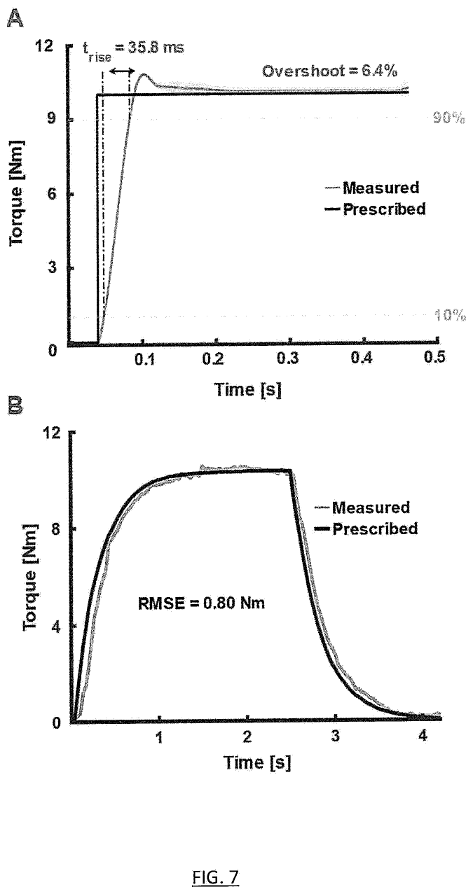

The low-level closed-loop PID torque controller was characterized to describe the level of assistance in terms of applied torque to the elbow joint. This characterization incorporated the custom strain-gage instrumented torque sensor capable of isolating and measuring the sagittal bending moment between the elbow joint pulley and forearm cuff. A torque tracking analysis evaluating the error between the measured and prescribed torque, shown in FIG. 7, determined the exoskeleton tracked the torque setpoint with a root-mean-squared error of 0.80 Nm at 500 Hz, while repetitively lifting a box with 12 Nm of elbow flexion assistance. Additionally, a step response benchtop test (FIG. 7) was conducted to characterize the response speed of a large setpoint change. The device achieved a mean rise time of 35.8 ms to a step change of 10 Nm. This characterization ensured the system would provide rapid assistance for quick movements. The measurement of a 35.8 ms rise time suggests that for a quick action lasting 1 second, the desired support could be provided throughout 96.42% of the motion.

### Battery Life Validation

Estimation of the overall runtime of the elbow exoskeleton under simulated work conditions was determined using an n=1 case study. The change in battery voltage was recorded over a 10-minute period in which a participant unloaded a table of 10 kg boxes onto shelves 10 meters apart while receiving 12 Nm of assistance during each carry, with a roughly 30% periodic downtime walking back to the original shelf between carries. Throughout the 10-minute period, the 1800 mAh battery capacity dropped by 7.6% with initial and final voltages of 25.18, and 24.78, respectively. Extrapolating this rate of power consumption until the battery's 6 cell voltages have dropped to 3.2 V (22.2 V total) results in an estimated use time of 2.2 hours, based on battery voltage and capacity relationships.

### Benefit Vs Load Comparison

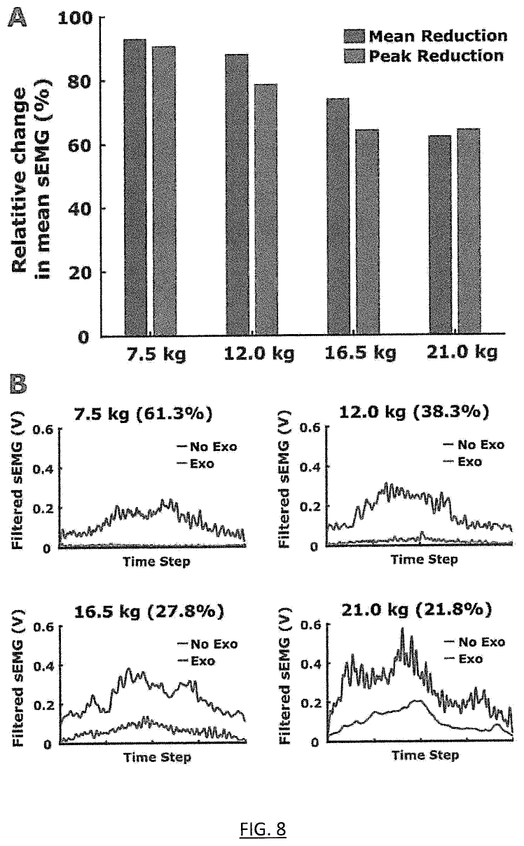

For the purpose of quantifying exoskeleton benefit as function of lifted load, a participant performed continuous box lifts with a metronome at 60 bpm for box weights ranging from 7.5-21.0 kg. The relative changes in mean surface electromyography (sEMG) with respective to percentage of load assisted were characterized with and without 12 Nm provided by the exoskeleton. The relationship between the percentage of load alleviated by the exoskeleton assistance and the relative reduction in mean sEMG follow a linear relationship between 21.8% and 38.3% with an R squared value of 0.987; beyond this level of assistance the reduction began to plateau. Given the participant's forearm length of 0.256 meters and an applied torque of 12 Nm per arm, the load assist for the 7.5, 12.0, 16.5, and 21.0 kg boxes are 61.3%, 38.3%, 27.8%, and 21.8%, respectively. The mean and peak reduction for the average lifting cycle (n=5) are shown in FIG. 8A while the overall waveform reduction in sEMG for the same data is shown in FIG. 8B.

### Biomechanical Responses to Simulated Real-World Lifting Tasks

To assess the performance of the elbow exoskeleton and its impact on user experience, a comprehensive experimental protocol was designed, incorporating objective measures of muscle activity and fatigue, and subjective metrics such as perceived exertion and comfort. The study aimed to evaluate the exoskeleton's effectiveness in reducing muscle strain, improving endurance, and maintaining comfort during prolonged usage.

### Experimental Setup

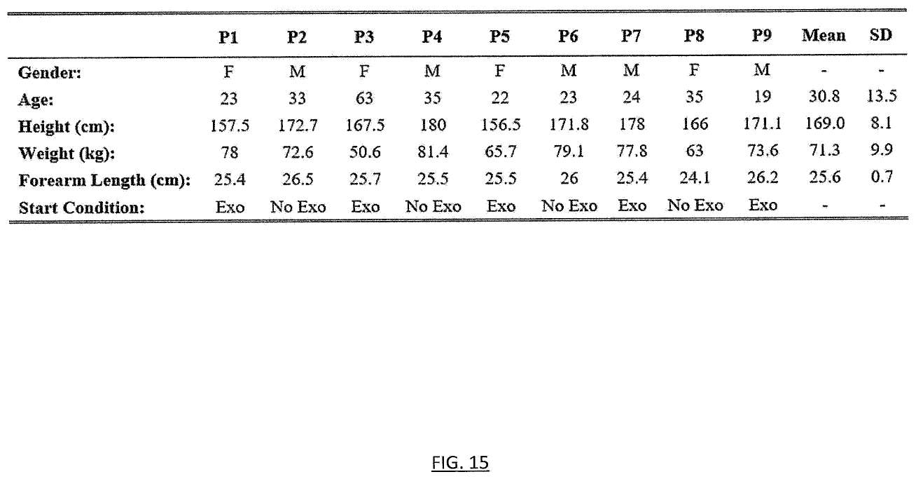

1) Participants: A total of 9 healthy participants (6 males, 4 females) aged between 19 and 63 years (mean of 30.8) without prior elbow exoskeleton experience were recruited for the study (Table of FIG. 15). Informed written and verbal consent was obtained from each participant, and individuals with a history of musculoskeletal disorders or neurological impairments were excluded to ensure a homogeneous sample. Participant height and weight ranged from 156.5-180 cm and 50.6-81.4 kg, respectively.

2) Task Descriptions: Each participant completed a series of three tasks designed to quantify the effects of the exoskeleton in a simulated work environment. The conditions were balanced and randomized to ensure half the male and female participants completed the tasks first with the exoskeleton, then again without the exoskeleton. The other half of each sex completed the task in the opposite order.

The first task, referred to as the Box Lift, required that participants repetitively lift or curl a 10 kg box from full elbow extension to 90 degrees of flexion for a total of eight cycles while maintaining synchronization with a metronome set to 60 bpm; such that a full cycle took 2 seconds. The second task called Box Loading required that a participant pick up and carry a 10 kg box over a 7-meter distance and then place the box on 0.75-meter-high table. The participant then picks up another box from that table and carries the box over the same distance to an identical table. The process is repeated until a total of ten carries are completed.

The third task was the Fatigue Lift, which required that the participants repetitively lifted a 20 kg box as many times as they could before fatigue was reached. The point of fatigue was defined by either muscle failure or the inability of the participant to maintain timing with the 60-bpm metronome. Participants were given 35 minutes of rest after performing the fatigue lift for both the exoskeleton and no exoskeleton start conditions before repeating the task in the remaining condition dependent on the block randomization between the sex.

Participants were given a demonstration of each task and asked to maintain consistent upright posture throughout.

Max voluntary isometric contraction (MVIC) of the biceps brachii short head and triceps brachii lateral head were performed on each participant's dominate arm to allow for sEMG normalization across participants and provide context to the changes in muscle activation magnitudes. For the biceps MVIC, participants were asked to maximally flex their forearm while holding a static strap with the elbow at 90 degrees and standing on a force sensing platform. Similarly, for the triceps MVIC, participants were asked to maximally extend their forearm while holding a static strap with the elbow at 90 degrees and standing on a force sensing platform.

3) Single Subject Overhead Tasks: One male subject (P2) completed two additional overhead tasks; these additional tasks were not completed by the entire n=9 cohort due to safety concerns with overhead lifting of heavy objects and strength disparities. The first additional task was the Box Press, which required the participant to press a 10 kg box from shoulder height to full overhead elbow extension as if they were pushing a box up onto a shelf, then back down to shoulder height. This task was performed continuously for a total of eight cycles and required the participant to maintain timing with the 60-bpm metronome. The second additional task was the Compound Lift, which was the fluid combination of the box lift task directly into the box press tasks. This compound task aimed to investigate the effects of quick transitions from flexion to extension. The Compound Lift required the participant to begin lifting the 10 kg box with their arms down in full elbow extension, up to their chest to complete elbow flexion, then to press the box upwards by extending their arms to full elbow extension above the shoulders and back down in a reverse manner. The task was performed continuously for eight repetitions in accordance with a 60-bpm metronome; such that a full cycle took 4 seconds.

4) Evaluation Metrics: To quantify muscle activity, sEMG electrodes were strategically placed on major upper extremity muscle groups around the neck, upper arm, and forearms. Specifically, sEMG sensors were placed on the flexor carpi radialis, the flexor carpi ulnaris, the biceps brachii short head, triceps brachii lateral head, and the trapezius pars transversa. The sEMG signals were recorded (1,000 Hz) during both baseline (no exo) and exoskeleton-assisted movements. The sEMG signals were band-pass filtered offline with a fourth order Butterworth filter (20-460 Hz cut-off frequency). Signals were then rectified and low pass filtered at 12 Hz. The sEMG signals were then normalized by participant-specific baseline MVIC. The collected data were analyzed to determine the change in muscle activity facilitated by the exoskeleton. During the fatigue lift the sEMG as well as the number of lifts until failure were recorded.

Participants were asked to rate their perceived exertion and comfort levels using standardized scales after each experimental condition. The Borg Rating of Perceived Exertion (RPE) scale was employed to assess the participant's perceived effort during activities with and without the exoskeleton. Similarly, a Borg-inspired comfort rating scale was utilized to gather qualitative feedback on the comfort levels experienced by participants during exoskeleton-assisted movements.

### Statistical Analysis

A two-tailed paired-sample t-test was conducted to assess the significance of mean muscle activity differences between exoskeleton-assisted and no exoskeleton conditions using an alpha of 0.05. Before testing, we checked for sample normality with the Shapiro-Wilks test; for non-normal distributions, we used the Wilcoxon Rank Sum test.

### Experimental Results

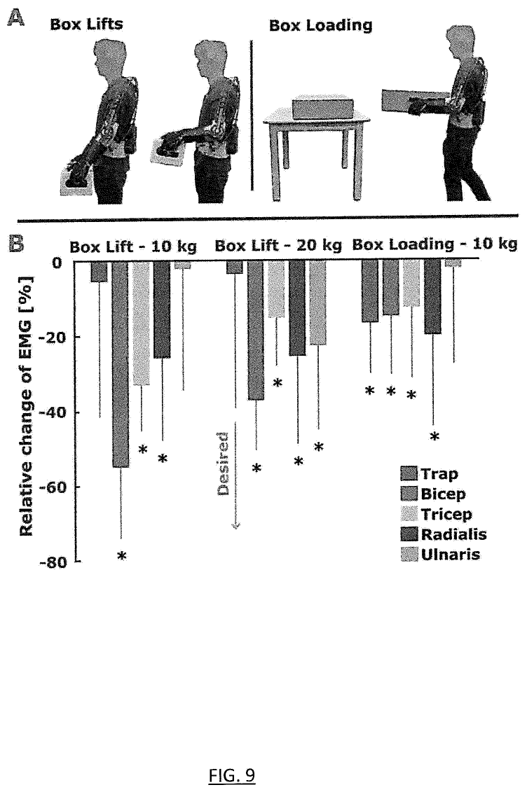

1) Muscle Activity: Significant reductions in mean muscle activity for each of the box lifting and loading tasks vs without the exoskeleton were found (FIG. 9).

Specifically, there were statistically significant differences (p<0.05) for the biceps brachii, triceps brachii, and flexor carpi radialis with vs without the exoskeleton for all tasks; while the flexor carpi ulnaris and trapezius pars transversa only showed a significant difference in the 20 kg box lift and 10 kg box loading tasks, respectively. The biceps brachii achieved the largest reduction of 55±19% (p=0.006) for the 10 kg box lift; this muscle had a 38±14% reduction (p=0.001) for the 20 kg box lift. The flexor carpi ulnaris was reduced in the heavier 20 kg box lift by 23±21% (p=0.025). The 10 kg box loading task yielded significant reductions in all muscles except the ulnaris.

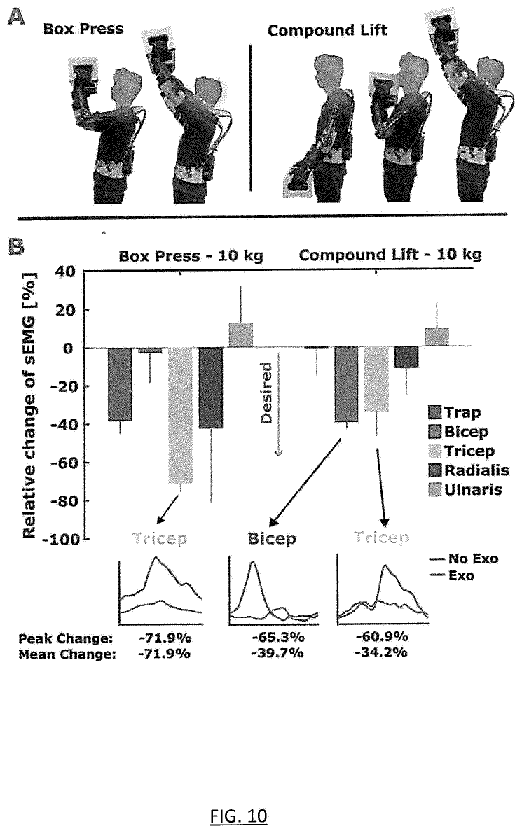

For the single subject test of the box press and compound lift tasks (FIG. 10), there was an observed a reduction of triceps activity by 79.1% and 32.2%, respectively, for with vs without the exoskeleton (n=1). Moreover, the box-press task yielded a large mean reduction of 39.8% in trapezious activity. For both the box-press and the compound-lift task there was an increase in mean Ulnaris sEMG by 12.7% and 9.3%, respectively.

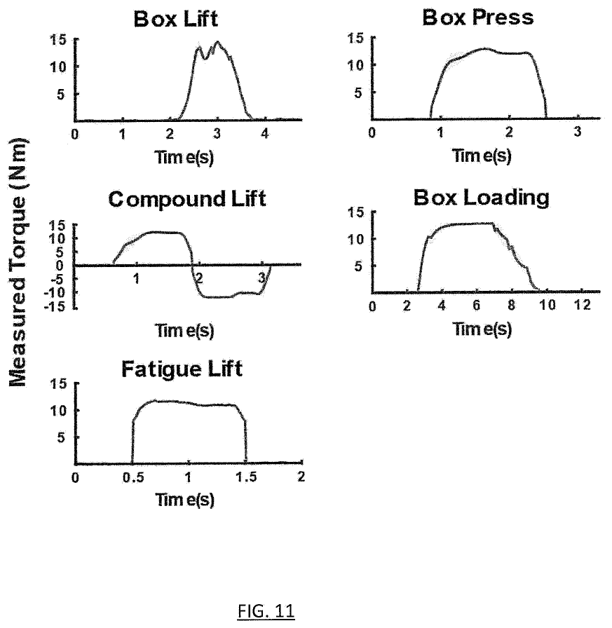

The torque delivery for each tasked aimed to provide 12 Nm of assistance at the elbow joint (FIG. 11). The torque was delivered gradually to minimize uncomfortable torque application. The rise time for this setpoint balanced discomfort associated with rapid delivery while maintaining an average delivery timing of 0.36 seconds.

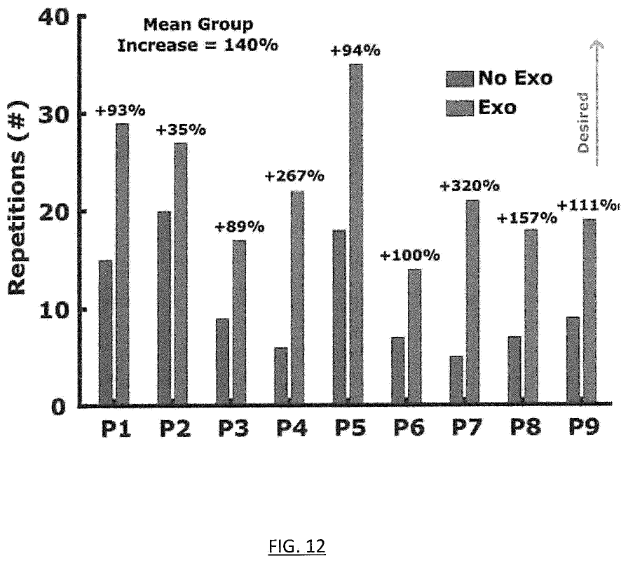

2) Endurance: The number of lifting cycles performed before musculoskeletal fatigue was substantially improved for each participant with vs without the exoskeleton. On average, the number of sequential lifting cycles while wearing the exoskeleton increased by 140±93% (p=0.004) when compared to no exoskeleton (FIG. 12).

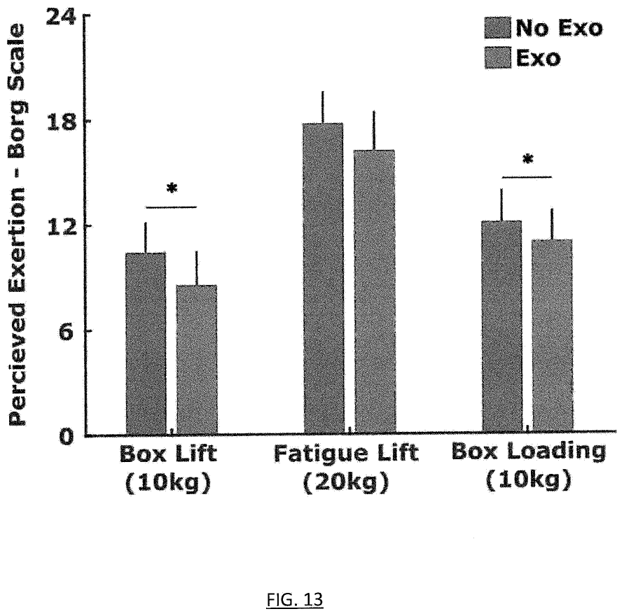

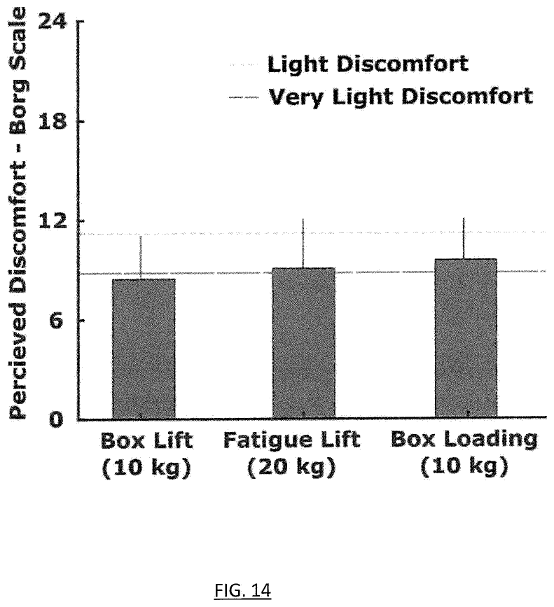

3) Perceived Comfort and Exertion: On average, participants reported a lower perceived exertion with vs without the exoskeleton for the box lift and box loading tasks (FIG. 13). There was no difference in perceived exertion for the fatigue lift, as expected, because that task was conducted until failure; both with vs without exoskeleton trials received an average rating of 17 associated with “very hard”. Notably, for the same level of perceived exertion, participants were able to achieve 2.4× more repetitions on average. The average perceived comfort across all trials was 9.1, corresponding with “very light discomfort” on the Borg inspired rate of perceived comfort chart (FIG. 14). The majority of the individual task rating averages fell between “extremely light” and “light” discomfort.

### DISCUSSION

In this study, we present the electromechanical design and validation of a novel lightweight elbow joint exoskeleton. We developed and employed a practical control strategy using pressure sensor gloves that allowed for consistent control of bidirectional assistance during manual lifting and pressing tasks. Our comparison of muscle activity during box loading and lifting tasks with vs without the exoskeleton demonstrated reliable, consistent reductions along the arms, neck, and upper-back that suggest this system may be suitable for reducing the risk of strain and overuse injuries in the workplace.

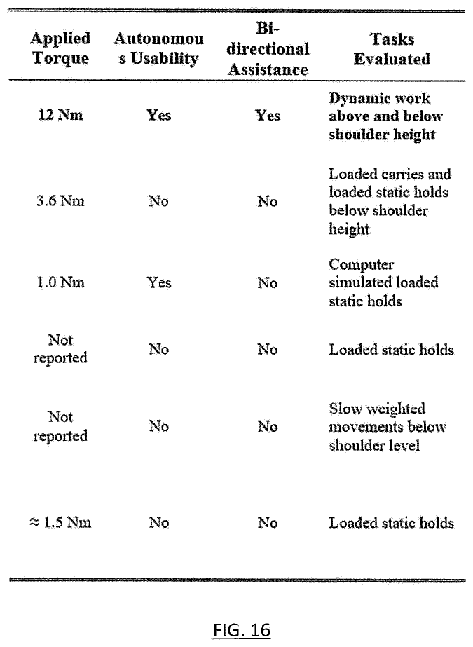

The electromechanical performance of our device helps establish a new benchmark for wearable elbow exoskeletons. To our knowledge, the only comparable active system documented in the literature is the pneumatic “Carry” exoskeleton with a response time between 1.5 and 13.4 seconds, depending on the state of the pressure vessel. At the time of this writing, other comparable elbow joint exoskeletons were limited by the torque transmission speeds inherent in design constraints associated with winding a cable or rotating a threaded rod. Additionally, the amount of elbow torque assistance applied in this study (12 Nm) was substantially higher compared to the 3.4 Nm or less described in previous studies (Table of FIG. 16). Moreover, our careful review of the literature suggests that there are no other lightweight bidirectional elbow-joint exoskeleton designs with autonomous control specific to box lifting and pressing tasks, as shown in the Table of FIG. 16.

In dynamic work environments where rapid and varied movements are common, controller responsiveness, user comfort and trust, and unimpeded motion when assistance is not desired are likely to be crucial for device adoption. One of the key features of our system was the ability to provide bidirectional assistance throughout dynamic load lifting and pressing tasks. The reduction in mean muscle activity observed in the compound lift task shown in FIG. 9 demonstrates the device could quickly identify a shift in the directional need for assistance from elbow flexion in the first half of the motion to elbow extension in the second half.

The system's step response and rise time were characterized ensuring torque could be applied quickly enough to provide relevant assistance during dynamic tasks, supporting up to 96.4% of a 1 second motion. However, in pre-study testing, we found that a more gradual torque application, implemented as a rise time of 0.36 seconds, was preferred because it resulted in more comfortable assistance.

Our device facilitated unhindered elbow motion during unloaded periods of upper limb tasks through zero-torque control of a torque-feedback PID controller that actively cancelled transmission friction. This was validated during the box loading scenario, where down time between pick and place movements utilized the zero-torque setpoint.

While there are several nice elbow exoskeleton designs presented in the literature specific to arm rehabilitation, there are very few published studies from which to compare our findings on lifting tasks (Table of FIG. 16). Our device facilitated reductions in bicep, trap, and radialis muscle activity by 55%, 5.5%, and 25.9% during box lifting, compared to a 30%, 19%, and 18% reduction facilitated by the Carry exoskeleton during static holds with the same weight.

However, in their protocol, they compared muscle activity between powered and unpowered exoskeleton usage. In this study, we compared with vs without the exoskeleton, which provides a more relevant comparison in muscle activity. Because simply wearing a device while it is unpowered likely increases muscle activity, the reductions reported in the literature may overestimate the benefit of their system.

The inclusion of comfort and perceived exertion evaluation metrics adds a key dimension to the evaluation of our wearable elbow exoskeleton (FIGS. 13 & 14). The favorable ratings in these areas suggest that the exoskeleton's design effectively balances functionality with user comfort; an aspect that is often challenging to achieve but critical for the adoption and long-term use of such technologies. Our elbow exoskeleton resulted in a favorable reduction in perceived exertion for both box loading and lifting tasks (FIG. 13). There was no difference in perceived exertion for the fatigue task, however this was expected because participants were asked to exert the same effort (“go to fatigue”) for both conditions; our participants were able to complete 2.4× more repetitions before failure with vs without the device at the same level of perceived effort. The perceived comfort for nearly all trials was between “light” and “very light” discomfort on the Borg inspired rate of perceived comfort chart (FIG. 14), which may suggest that elbow exoskeletons could be well tolerated for industrial work settings.

In conclusion, our experimental human subjects testing and validation, particularly the significant reduction in muscle activity and increase in endurance during lifting tasks, provide promising evidence of the exoskeleton's effectiveness. These findings are a crucial first step towards demonstrating efficacy in real-world workplace environments. The demonstrated benefits of this device may translate into lower fatigue levels and reduced injury rates among industrial workers, in so improving productivity and overall workplace safety.

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

The invention claimed is:

1. A processor-implemented method of controlling the application of assistive force to an elbow joint of a user wearing a powered arm exoskeleton, comprising:
receiving, at a processor, a measure of pressure applied by the user's fingers from one or more pressure sensors arranged over a palm-side of one or more of the user's fingers in an instrumented glove;
receiving, at the processor, a measure of pressure applied by the user's palm from one or more pressure sensors arranged over the user's palm in the instrumented glove; and
directing an actuator to actuate the powered arm exoskeleton to apply either flexion or extension assistive torque between the user's forearm and upper arm based on the measure of pressure applied by the user's fingers and the measure of pressure applied by the user's palm.

2. The method of claim 1, wherein directing an actuator to actuate the powered arm exoskeleton to apply either flexion or extension assistive torque between the user's forearm and upper arm based on the measure of pressure applied by the user's fingers and the measure of pressure applied by the user's palm comprises:
comparing the measure of pressure applied by the user's fingers to a first finger pressure threshold;
comparing the measure of pressure applied by the user's palm to a first palm pressure threshold;
if the measure of pressure applied by the user's fingers is less than the first finger pressure threshold and the measure of pressure applied by the user's palm is less than the first palm pressure threshold, directing an actuator to actuate the powered arm exoskeleton to apply flexion and extension assistive torque sufficient to overcome an inertia of the powered arm exoskeleton during the user's arm movements.

3. The method of claim 2, further comprising receiving, at the processor, a measurement of an angular direction of movement between an upper arm portion of the exoskeleton and a lower arm portion of the exoskeleton, and directing the actuator to actuate the powered arm exoskeleton to apply flexion assistive torque if an angle between the upper arm portion and the lower arm portion of the exoskeleton is decreasing and extension assistive torque if the angle between the upper arm portion and the lower arm portion is increasing.

4. The method of claim 1, wherein directing an actuator to actuate the powered arm exoskeleton to apply either flexion or extension assistive torque between the user's forearm and upper arm based on the measure of pressure applied by the user's fingers and the measure of pressure applied by the user's palm comprises:
comparing the measure of pressure applied by the user's fingers to the measure of pressure applied by the user's palm;
comparing the measure of pressure applied by the user's fingers to a second finger pressure threshold; and
if the measure the measure of pressure applied by the user's fingers exceeds the measure of pressure applied by the user's palm and the measure of pressure applied by the user's fingers exceeds the second finger pressure threshold, directing the actuator to actuate the powered arm exoskeleton to apply flexion assistive torque between the user's forearm and upper arm.

5. The method of claim 1, wherein directing an actuator to actuate the powered arm exoskeleton to apply either flexion or extension assistive torque between the user's forearm and upper arm based on the measure of pressure applied by the user's fingers and the measure of pressure applied by the user's palm comprises:
comparing the measure of pressure applied by the user's fingers to the measure of pressure applied by the user's palm;
comparing the measure of pressure applied by the user's palm to a second palm pressure threshold; and
if the measure the measure of pressure applied by the user's palm exceeds the measure of pressure applied by the user's fingers and the measure of pressure applied by the user's palm exceeds the second palm pressure threshold, directing the actuator to actuate the powered arm exoskeleton to apply extension assistive torque between the user's forearm and upper arm.

6. The method of claim 1, wherein directing an actuator to actuate the powered arm exoskeleton to apply either flexion or extension assistive torque between the user's forearm and upper arm based on the measure of pressure applied by the user's fingers and the measure of pressure applied by the user's palm comprises directing the actuator to provide a predetermined level of either flexion or extension assistive torque.

7. The method of claim 6, further comprising, receiving a user input and determining the predetermined level of either flexion or extension assistive torque on the basis of the user input.

8. The method of claim 1, further comprising receiving from a torque sensor a measure of user-applied torque between an upper arm portion and a lower arm portion of the exoskeleton, and providing either flexion or extension assistive torque on the basis of the user applied torque.

9. The method of claim 1, wherein directing an actuator to actuate the powered arm exoskeleton to apply either flexion or extension assistive torque between the user's forearm and upper arm based on the measure of pressure applied by the user's fingers and the measure of pressure applied by the user's palm comprises applying a scale factor to the measure of pressure applied by the user's fingers or the measure of pressure applied by the user's palm and directing an actuator to actuate the powered arm exoskeleton to apply either flexion or extension assistive torque between the user's forearm and upper arm in accordance with the scaled pressure measure.

10. The method of claim 1, wherein receiving, at a processor, a measure of pressure applied by the user's fingers from one or more pressure sensors comprises receiving a plurality of finger pressure measurements from pressure sensors arranged at a plurality of a user's fingers.

11. The method of claim 10, wherein the measure of pressure applied by the user's fingers comprises an average of the received finger pressure measurements from pressure sensors arranged at a plurality of a user's fingers.

12. The method of claim 1, wherein receiving, at a processor, a measure of pressure applied by the user's palm from one or more pressure sensors arranged over the user's palm comprises receiving a measure of pressure applied by the user's palm from a pressure sensor arranged over the user's thenar eminence.

13. An exoskeleton device, comprising:
a control unit including a controller; a first actuator; and a second actuator; a first hinged assembly actuated by the first actuator; a second hinged assembly actuated by the second actuator; and a first and second instrumented gloves each including one or more pressure sensors arranged a palm-side of a user's fingers and one or more pressure sensors arranged over the user's palm;
the controller configured to adjust a level of torque provided by each of the first and second actuators,
wherein the first actuator includes a first shaft extending therefrom and the second actuator includes a second shaft extending therefrom, and the first shaft engages a first sprocket configured to displace a first cable coupled to the first hinged assembly to effect movement of the first hinged assembly and the second shaft engages a second sprocket configured to displace a second cable coupled to the second hinged assembly to effect movement of the second hinged assembly.

14. The device of claim 13, wherein the first hinged assembly comprises:
a first linear, structural member configured to removably couple to an upper arm of a user;
a second linear, structural member configured to removably couple to a forearm of the user; and
a rotational bearing rotationally coupling the first and second linear, structural members.

15. The device of claim 14, wherein the rotational bearing is coupled to a first pulley, and wherein the first cable is coupled to the first pulley such that rotation of the first shaft by the actuator applies rotational force to the pulley thereby rotating the second linear, structural member with respect to the first linear, structural member.

16. The device of claim 15, wherein the first cable is a Bowden cable, having an outer sheath and an inner cable, wherein the outer sheath is anchored to the first linear, structural member and the inner cable is coupled to the pulley.

17. The device of claim 14, wherein the first linear, structural ember is configured to be coupled to the upper arm of the user by an orthotic cuff, and wherein a rotational axis of the rotational bearing is configured to be collinear with a rotational axis of an elbow joint of the user's arm when the second linear structural member is coupled to the forearm of the user.

18. The device of claim 13, wherein the controller is configured to:
receive data from the one or more pressure sensors arranged a palm-side of a user's fingers and one or more pressure sensors arranged over the user's palm, determine, using the data from the sensors, a current state value,
determine a control instruction based at least on the current state value, and
operate the first actuator based on the control instruction.

19. The device of claim 13, wherein the first actuator and the first hinged assembly are configured such that the first actuators can provide extension torque to the elbow of a user wearing the device by displacing the cable in a first direction, and flexion torque to the elbow of a user wearing the device by displacing the cable in a second direction.
